(19) United States
(12) Patent Application Publication
(10) Pub. No.: US 2013/0264210 A1
(43) Pub. Date: Oct. 10, 2013

(54) COMPREHENSIVE COMPACT UNIT FOR THE TREATMENT OF EFFLUENTS AND/OR SEWAGE AND SYSTEM THAT USES IT

(71) Applicants: Jorge Luis Cobas, Ciudad Autonoma de Buenos Aires (AR); Pablo Jose Santiago Closas, Provincia de Buenos Aires (AR); Ricardo Antonio Persino Lavalle, Ciudad Autonoma de Buenos Aires (AR)

(72) Inventors: Jorge Luis Cobas, Ciudad Autonoma de Buenos Aires (AR); Pablo Jose Santiago Closas, Provincia de Buenos Aires (AR); Ricardo Antonio Persino Lavalle, Ciudad Autonoma de Buenos Aires (AR)

(73) Assignees: Jorge Luis COBAS, Ciudad Autonoma de Buenos Aires (AR); Nora Maria NOVARINI, Gulfport, MS (US); Ricardo Antonio PERSINO LAVALLE, Ciudad Autonoma de Buenos Aires (AR); Pablo Jose Santiago CLOSAS, Provincia de Buenos Aires (AR)

(21) Appl. No.: 13/992,897

(22) PCT Filed: Dec. 8, 2011
(86) PCT No.: PCT/US11/63914

§ 371 Date: Jun. 10, 2013

(30) Foreign Application Priority Data
Dec. 10, 2010 (AR) P 2010 0104596

(51) Int. Cl. C02F 1/463

(52) U.S. Cl. CPC C02F 1/463
USPC 204/660

(57) ABSTRACT

A comprehensive and independent unit for the treatment of Effluents or Sewage and the system that uses it. This unit requires little space and it has a high capacity to mitigate effluent parameters. This treatment is performed by means of a single reactor which carries out the electrocoagulation, electro flocculation, electro flotation, electrooxidation and electrohydrolization and it drains in a high performance decanter which is a single container. The unit is composed of a reactor (4) that sends its clotted effluents into a decanter (5) and its foam into a foam collector (6). The decanter (5) is placed adjacent to the foam collector (6) and has the capacity to discharge its foam into the collector (6); the whole process is carried out without the need for any auxiliary recirculation devices.

### TECHNICAL FIELD OF THE INVENTION

The present invention refers to a compact comprehensive unit for the treatment of Effluents or Sewage (organic effluents) and the system that uses it. This unit requires little space and it has a high capacity to mitigate effluent parameters. This treatment is performed by means of a single reactor which carries out the electrocoagulation, electroflocculation, electroflotation, electrooxidation, and electrohydrolization and it drains into a high performance decanter which is a single container.

### STATE OF PRIOR ART AND OBJECT OF THE INVENTION

It is known that industries, laboratories, restaurants, hospitals, or other generators of pollutant effluents (even those with a very low level of pollution) often fail to comply with the effluents parameters, whether domestic or international, and they have a negative impact on the environment.

One of the reasons that these institutions or businesses set out to justify their breach of effluents regulation is that in order to do so, they need to have a significant surface available to install the equipment in straight line, thereby removing productive surface in the case of large surface industries, or directly making it impossible to implement in the case of small businesses with small surfaces.

In the current state of the art, one of the alternatives used in reduced spaces consists in the treatment of effluents by means of flocculation as a consequence of the addition of chemical products.

The first consequence of this process is the logistics problem as regards the handling of inbound chemical aggregates plus the withdrawal of said chemical products in the form of sludge in a later stage. According to the size of the plant, it could go from hundreds to tons of kilograms that have to be moved.

The second direct consequence is that, in each case, it should be analyzed whether said sludge is pollutant or not, and whether the following procedure for the treatment of “hazardous waste” should be carried out. The rise in logistics costs is evident in these cases.

Another recurrent problem in the state of the art related to the handling of sludge is that, depending on the volume to be treated, the exhaustion of heavy sludge may be periodic or, at most, every 2 days. This operation, according to the current systems in the art, is usually difficult and is carried out by qualified staff, thus increasing the process costs.

The processes of electro-flocculation entail complicated procedures as regards the routine control, cleaning and renewal operating procedures of electrodes involved in the reactor, and it is necessary to resort to auxiliary devices, such as winches, cranes, or riggings.

One of the objects of this invention is to provide a unit for the efficient treatment that allows all those industries, laboratories, restaurants, hospitals, or other generators of pollutant effluents, even the ones with a very low level of pollution, to comply with the strictest effluent parameters, whether domestic or international. The unit also proposes a minimal utilization of space at a low cost, dismisses the need of previous preparation of the land, and assures there is no negative impact on the environment. This possibility obviously extends to all those industries that have larger spaces and wish to increase their productive surface,

[symbol]

Another main object of the present invention is to provide a system in which the exhaustion of heavy sludge may be carried out in a simple way by any person who is not specifically qualified for this process; for example, someone in charge of plant maintenance.

Another main object of this invention is to provide a unit in which the control, cleaning and renewal operating procedures of electrodes in the reactor for the flocculation process could be carried out in a simple way by any person that is not specifically qualified and without the need of additional equipment, such as winches, cranes or riggings.

Another object of the invention is to provide a system that allows the application of the treatment unit with particular technical characteristics.

### ADVANTAGES AND DIFFERENCES REGARDING THE PRIOR ART

One of the main features of the present invention is a drastic reduction in the size of the current treatment unit in comparison to the conventional plants nowadays known by using existing technologies, combining them in an innovative way and including improvements in several significant points.

Furthermore, although the amount of effluents to be treated is the same, not only the space but also the process timing is reduced, as well as the costs for raw materials and maintenance.

Another important difference from the prior art is that this process aims simultaneously at both groups of pollutants, whether they are organic (sewage or pathogenic) or inorganic (industrial). It is also possible to apply it to processes of water purification.

In addition, since it is modular equipment, it can be interconnected one after the other, according to the aggressiveness of the effluents to be treated. Moreover, it can be easily transported by a medium work vehicle as it is a compact and light unit.

Another difference regarding the treatment units of the prior art is that the sludge generated by the process is neither toxic nor pollutant for all industrial and/or sewage waste, excluding radioactive waste. This is a very important result for the handling of such sludge and for its final disposal, which is eased by the particular configuration of the tanks at the lower part, with their corresponding connections for disposal; this allows the process of disposal of heavy sludge to be done periodically by any person who is not specifically qualified (for example, a person in charge of plant maintenance) thus reducing operating costs.

Moreover, the control, cleaning and renewal operating procedures of electrodes involved in the reactor are carried out in a simple way due to the design of this equipment, without the need of resorting to additional tools, such as winches, cranes or riggings for its handling.

### SUMMARY OF THE INVENTION

This compact unit for the treatment of effluents and sewage waste includes a reactor that contains a combined electrode with two continuous stages, in a preferred form of Iron and Aluminium that carries out the primary treatment through electrolysis, electrocoagulation, electroflocculation, electroflotation, and electrooxidation.

For illustration purposes a user will install the unit of this invention as intermediary between a container that collects the crude effluent (cistern tank), and the usually known Sample Collection Chamber at the end of the system.

The liquids to be treated are extracted from the “Cistern Tank” by [symbol] they are introduced into the reactor. Said pump is the only electromechanic source through which the effluents enter the equipment.

Moreover, the flow of effluents entering the reactor is regulated by a set of valves according to the necessary residence time to guarantee the settlement process according to the effluent to be treated. In addition, the fluid zigzags through the plates inside the reactor due to the system and to the assembly of the electrodes, increasing the time that takes to process each molecule of polluted water.

Since the flow is constant, the liquid in process, with its ions and sludge, is directed and dragged due to its dynamics by supernatant, from the upper part towards the base decanter.

At the top of the reactor there is a particular structure with the shape of a funnel, which is described below in more detail, which has a foam trap inside, preventing the foam to infiltrate into the decanter. At the same time, the excess of foam generated by the reaction is collected by the supernatant at the lateral face of the reactor, and it is directed to the “foam collector.”

In this container, the foam is sprayed and dissolved by the liquids collected by the submersible pump and they do not enter the reactor directly due to the by-pass. Said by-pass is responsible for the flow adjustment mentioned before.

The aforementioned spraying is a desired effect in order to mix, dissolve and drag the foam back to the cistern tank, so it can be part of the treatment circuit again.

As far as the decanter is concerned, its volume is several times larger than the reactor's, and it must be noted that, at this stage, the access to the reactor happens without intermediate pumps.

On the other hand, from the upper cell of the reactor, the flocculated [symbol] on a plate containing a series of diamond-tip shapes in order to prevent any type of turbulence and to achieve a loss of speed of the liquids. In this way, a quick settling of the floccules or sludge of the process is assured. As the treated liquids fill the main decanter, they flow into the upper decanter.

The upper part of the decanter is tilted and has the special feature of bearing a series of sheets therein which, due to the angle and distance between them, they cause the loss of kinetic energy in the floccules, thus accelerating the settlement process.

In the upper part of the decanter there is another “funnel” with its corresponding foam trap. The already treated liquid is extracted from this funnel. It is free of pollutants and solid parts, in compliance with the necessary requirements to be discharged in the sewer system, drains or wells. The detailed explanation of the parts highlights the easy maintenance and cleaning of the unit, both for removal of sludge and for the change of electrodes.

### BRIEF DESCRIPTION OF THE FIGURES

In order to clearly understand this invention and to easily practice it, the Figures attached to this report, which are of illustrative and non limiting nature, show one of the best ways to embody said invention:

FIG. 1 displays the treatment system for the application of the treatment unit of this invention;

FIG. 2 displays an exploded view and positional views of the electrodes located inside the reactor;

FIG. 3 shows an upper view of the set of electrodes displayed in FIG. 2;

FIG. 4 is a rough diagram of the connection of the reactor

[symbol]

FIG. 5 is a perspective of the treatment unit of this invention;

FIG. 6a displays the decanter of the treatment unit of this invention;

FIG. 6b displays the reactor of the treatment unit of this invention and its corresponding support base;

FIG. 6c displays the foam collector of the treatment unit of this invention;

FIG. 6d displays the reactor of the treatment unit of this invention;

FIG. 7 shows a second perspective of the reactor displayed in FIG. 6b;

FIGS. 8a, 8b, and 8c display constructive details of the reactor of the treatment unit of this invention;

FIG. 9 shows an upper view of the reactor and its plates or inner electrodes;

FIG. 10 illustrates the movement of the foam from the reactor towards the foam collector;

FIG. 11 shows details of the lower channeller of the foam collector displayed in FIG. 10;

FIG. 12 shows a perspective of the decanter of the treatment unit of this invention;

FIG. 13 shows the movement of the fluids inside the decanter of the unit of this invention;

FIG. 14 show the inner plate of the decanter displayed in FIG. 13, including its diamond-tip shapes.

FIG. 15 shows the flow of liquids caused by the submersible pump located in the cistern tank.

In all Figures, the same or similar elements of the invention are

[symbol]

### DETAILED DESCRIPTION OF THE INVENTION

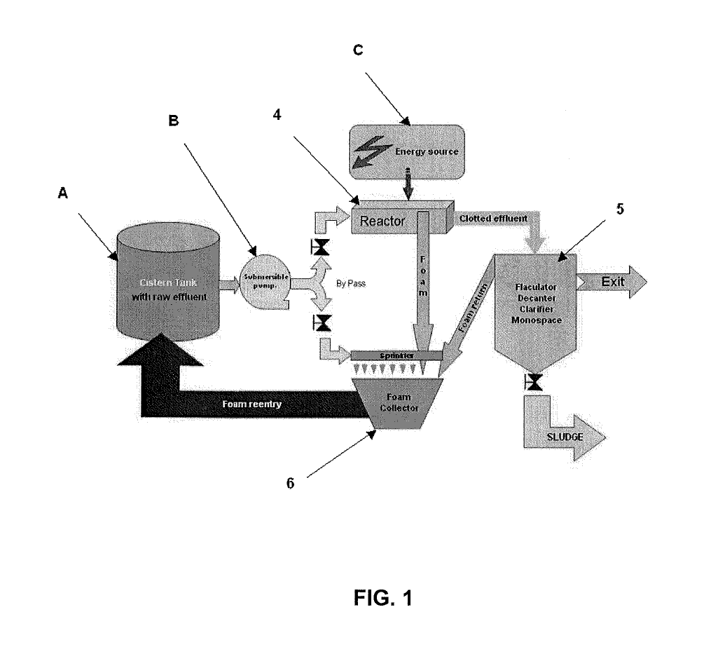

FIG. 1 shows the system for the treatment of effluents and sewage, which includes a cistern tank “A” connected to a submersible pump “B” that can take the fluid into the reactor 4. The electrodes in the reactor have a source of energy “C”, so the coagulated effluents flows into the decanter 5 and the foam goes to the foam collector 6.

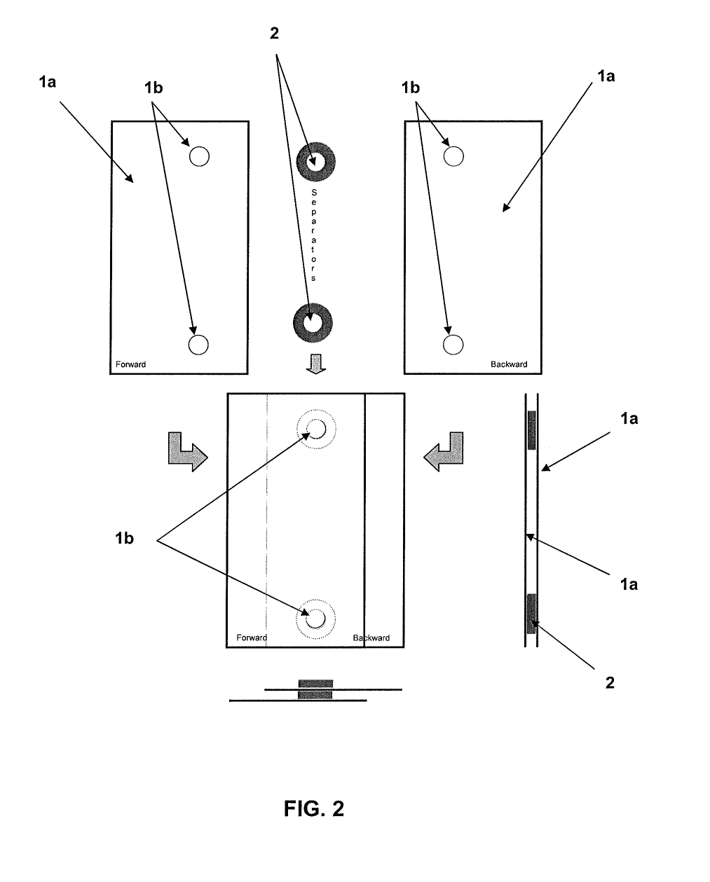

FIG. 2 shows each of the electrodes 1a with off-centered holes 1b and circular dielectric separators 2 located in said holes 1b. They are close to the far ends of said electrodes 1a. FIG. 3 shows those positioning and support axes inserted in the holes of each electrode and circular separators that are part of the unit.

Inside the reactor, electrodes with added materials 1a and 1b and/or plate sheets of inert materials are used to generate the electrocoagulation. For the cell assembly in the electrodes 1a there are off-centered holes 1b in the upper and lower parts of said electrodes. When the reactor is set up placing the cells horizontally inverted, spaces will be generated alternatively by the vertical sides. The liquid will zigzag through these spaces as in a piston flocculator, while the addition of the flocculant ions is carried out.

For the assembly of the reactor, two guide axes 3 of dielectric material are used. These are joined in the upper and lower parts of the plates. Bushings of dielectric material are used as separators 2 of the plates; they are specifically designed for this purpose. The bushings are placed between the plates la during the threading with said axes 3.

In this preferred embodiment, the plate sheets or the electrodes 1a of the same material but twice as thick will be placed in the inner points of [symbol] already been built and insulated in the connection area with insulating paint or adhesive. The insulating materials must be resistant to chemicals and they must exceed the insulated perimeter in about 3 mm.

Two plate sheets of the added and/or inert substances will be placed, separated from each other at a distance “D”; afterwards, the plates of insulated electrodes will be inserted between them in an equidistant way “N”, with N+1 dielectric separators designed for such purpose.

After that, these plates “N” will be distributed in such a way that the fill material with the largest atomic mass is at the beginning of the group (entrance), followed by the lightest towards the end (exit) and after the plates of inert material exist.

Then, four conductors will be placed: two in the plates at the far ends and two distributed in an equidistant way, so there are three units, preferably with the same amount of plates.

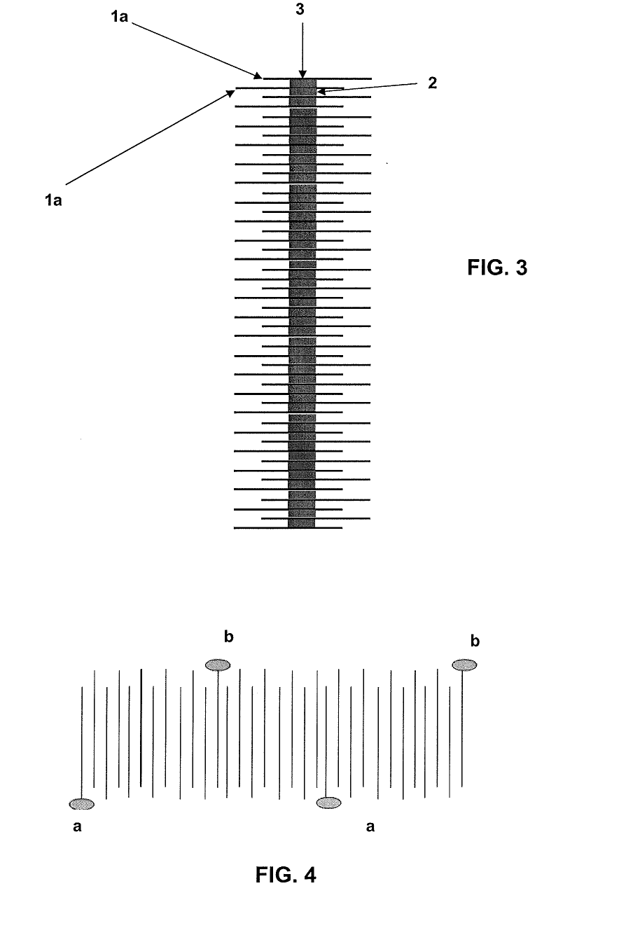

Afterwards, they will be connected alternatively to the two terminals “a” and “b” of the source controller. FIG. 4 shows what it should look like.

When the group of plate sheets is completely assembled, it will be placed together with a lateral sealing gasket that closes the small unwanted gap between the electrodes and the container cabinet of the reactor, thus improving the flocculation and the overall performance.

The liquid will flow in parallel towards the plates and they will zigzag according to the known piston flocculator. This will start the flocculation, oxidation, hydrolization and electroflotation, while the liquid is flowing in the reactor. For different types of conductivity, the plates can be connected to tension “U” to a bigger or smaller distance than that of “D.”

In addition, the reactor allows the release of the generated foam, which is later sent to the entry cistern.

The lid of the container in the reactor can be easily removed in order to clean it and to change the reactors.

The outlet of the liquid towards the decanter is carried out by means of a foam separator of a supernatant type, which drains in a spillway with a flowmeter. This adapts the process flow of the device to the flow of the effluent generator. In this case, the preferred capacity is obtained with a V-shaped outlet, where the height of the liquid above the lower vertex is proportional to the flow in m3/hour, according to the table.

Regarding the electronic circuit, it works as follows: tension is delivered periodically during a certain amount of time in seconds, with direct polarization t_{d}, and then everything is disenergized; after a certain amount of time tₒ, tension with the inverse polarization is delivered again and then everything is disenergized. This process continues indefinitely. This is done in order to prevent the electrodeposition of metals and salts in the sides of the electrodes, and to regulate the amount of flocculant material according to the Faraday equation Nm=F×Q (number of moles=Faraday constant×the charge.)

According to the aforementioned:
The energized time is tₑ=t_{d}+tᵢ
The disenergized time is tₐ=2*tₒ
The total amount of time per cycle is t_{T}=t_{d}+tᵢ+2*tₒ

For purposes of regulating the amount of fill material, and the level of oxidation and oxygenation, t_{d} and tᵢ are increased or reduced simultaneously, and tₒ is increased or reduced in order that t_{T} remains constant.

The resulting ionic charge (Q) equals the electric current that flows in the reactor (I) multiplied by the number of plates Nₚ minus one, multiplied by the energized time tₑ of the current.

[Coulomb]=[Amper]×[Adimensional]×[Second]

Q=I×(Nₚ−1)*tₑ
F: Faraday Constant The approximate amount of moles of atoms delivered by each type of non-inert electrodes will be Mₑ₁, Mₑ₂, where:

Mₑ₁=0.7F*I×Nₚₘ₁×tₑ

Mₑ₂=0.7F*I×Nₚₘ₂×tₑ

The amount of nascent oxygen produced will be approximately:

M_{eO}=0.5F×I×N_{pInert}*tₑ

The hydroxyl and hydronium masses will be approximately:

M_{eHO}=0.5F×I×N_{pInert}*tₑ

The number and type of plates actually used in the process will depend on the type and volume of the water to be treated and on the intended final quality.

The liquid is made flow with the controller set in minimum tₑ and the source and the controller are energized.

In all of them, the reactions will be caused through induction and

[symbol]

Regarding the electric data and in a preferential way of carrying it out, it is used a power supply of 380/220/110V rectified AC.

Moreover, it works between 0 to 60 degrees Celcius and the duration of the electrocoagulation process t_{d} o tᵢ lasts, at least, one second. The advised duration of each cycle or t is of 60 seconds, and the duration of the process inside the reactor is of at least 900 seconds.

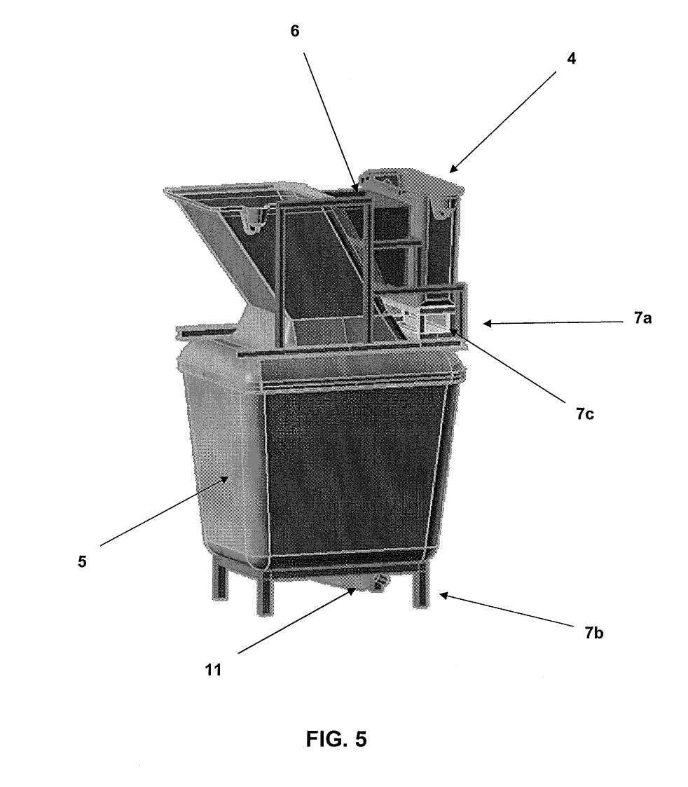

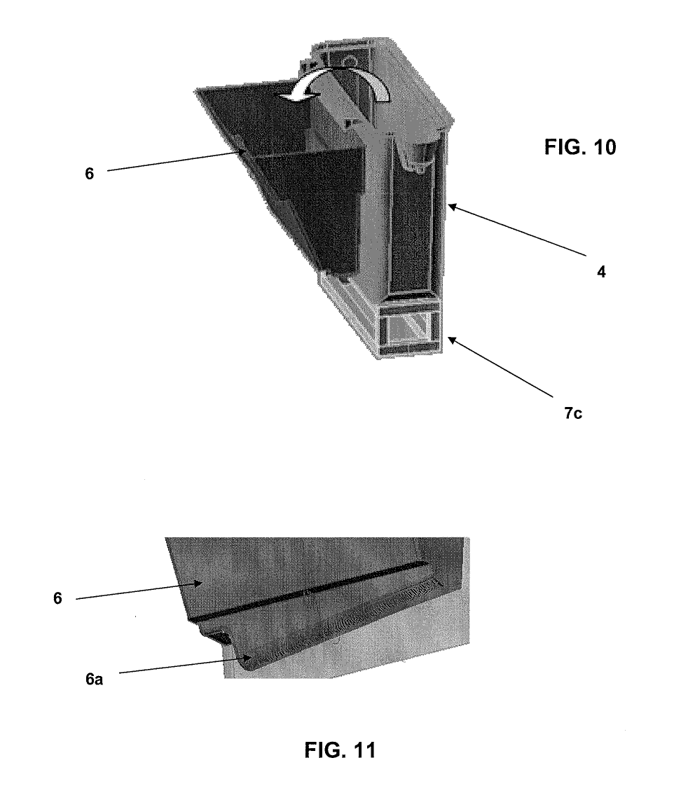

It is possible to see in FIGS. 5 to 13 the components of the unit of treatment of this invention: the reactor 4 through which the aforementioned liquid enters, flows towards decanter 5 and to the foam collector 6, and a structure of support 7a and 7b which help bear respectively the reactor 4 with the adjacent foam collector 6 and the decanter 5.

There is a second embodiment for carrying out this process in which all the aforementioned electric data is kept but the position of the electrodes, called ‘piston flocculator’ in the first stage, is replaced by another one called ‘cascaded’. This entails consecutive trays, which contain the electrodes electrically connected in the proper way, located over the reactor (4). The liquid will flow through them, from one tray to the next by free falling until it enters the reactor, and the previously described process continues.

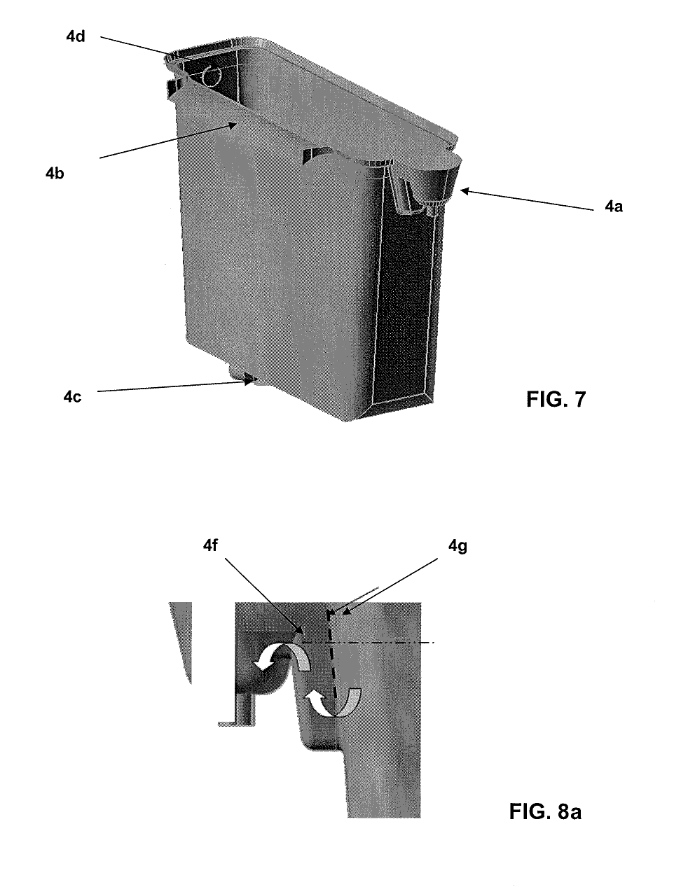

In this preferred example, the reactor 4, shown separately in FIG. 7, is composed of a plastic component or tank which works as a container for the circulating liquids and for the previously mentioned metal electrodes 1a which are responsible for the electroflocculation process, the main characteristic of how this unit works.

The dimensions of the reactor 4 are closely related to the dimensions of the electrodes 1a since, based on the design and proper assemble of them, the liquid to be processed flows through them. This is why a flexible

[symbol]

In said tank, there are three special components 4a, 4b and 4c which have specific functions and which will be conveniently explained in the “process”. These components, designed ad hoc, are built in the tank-reactor 4 and not added to the plastic tank.

This unit does not use any recirculation pumps for the liquid to be treated. The liquid circulates through communicating vessels or supernatant, that is through the natural fall of the liquid.

However, the only existing pump which forces the circulation is placed outside the unit and it is a submersible pump B located inside the cistern tank A where the effluents are gathered according to each factory. The liquid is sucked from pump B and sent to the entrance of the reactor 4 through hoses or plumbing.

The liquid to be processed enters the unit at point 4d shown in FIG. 7, (entry to reactor), through a passing threaded pipe which is firmly fixed in its place. An elbow is used to connect the inside of this pipe to another pipe which leads to the lower part of the entrance chamber of the reactor.

From that point, the liquid zigzags through the electrodes 1a, as shown in FIG. 9 (as if it were an upper view of the reactor tank 4), interchanging energy with them and generating flocculation, oxygenation and hydrolysis, which are the processes that cause the purification of the liquid.

Once the liquid flows through all the electrodes 1a, it reaches the exit chamber of the reactor; therefore, the entrance of the liquid is on the opposite side of the exit of the liquid. Furthermore, the entrance of the liquid is on the lower part of the entrance chamber and the exit is on the upper part of the reactor.

It is on this upper part 4a of the tank that there is what we will call a

[symbol]

The first function of this funnel 4a is that it contains a “foam trap” which prevents the foam generated in the process from going into the following stage which is the settling of the flocculated liquid. This function of separating the foam improves much more the overall performance of the unit, and of the decanter 5 in particular.

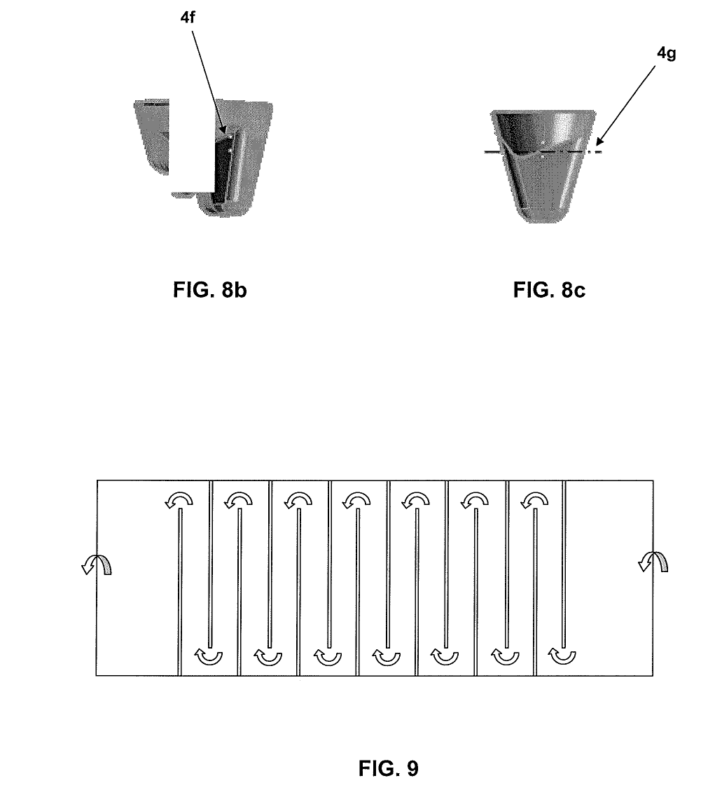

The second function of the “funnel” 4a is that it has an inclined plane 4f over which the liquid flows due to supernatant, and creates the possibility of visual control of the liquid flowing. The inclined plane 4f allows for the magnitude of the liquid flowing, which flows in a very simple way, to be easily seen, as shown in FIG. 8a with the dotted line 4g.

This possibility of seeing the liquid flowing is very important, when calibrating each unit, for the adjustment of the amount of liquid to flow through the unit since this amount may vary according to the type of liquid to be treated in each case.

Another “way” to be highlighted is shown in FIG. 7 with the reference 4b which will be called “foam tray”.

From the point of view of the process, it was said that the electroflocculation process precisely generates floccules which bind thus increasing their mass, and finally settle due to their own weight. But not all the floccules are heavy and settle, there is a certain amount of floccules which, depending on the chemical component of the liquid, are lighter than water and float, turning into “foam” over the water level fixed inside the reactor tank.

For example, if said liquid contains detergent, a certain amount of foam will tend to appear. This amount will depend on the effluents to be treated in each case.

Therefore, a “tray” 4b was designed for dumping all the foam generated in the reactor 4 in another plastic tank 6 referred to as foam collector. In FIG. 11, the arrow shows the circulation of the foam.

How this foam, in contact with the water, which is dumped in the aforementioned tank, is dissolved by making it flow into the cistern tank is described in detail subsequently.

Regarding the shapes of the reactor tank 4, the design of the tray 4b, by definition, has a difference of height with the funnel 4a to allow the proper operation of the unit.

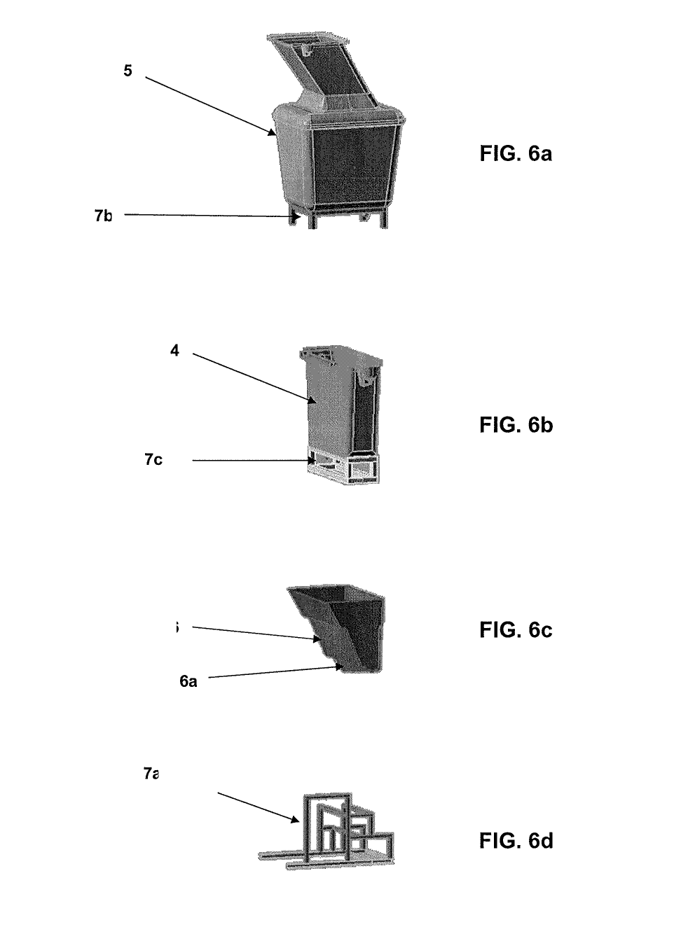

Finally, the reactor 4 rests and it is fixed by a proper elastomer adhesive to a metal base 4e built with a square structural pipe shown in FIG. 6b.

This metal structure 4e on which the plastic tank of the reactor 4 rests is necessary because the third highly important feature for the maintenance of the unit lies in the lower part of it, indicated with the number 4c, and it is called “sludge channeller”. This feature will be used in all the tanks of this unit.

Said feature consists in an inclined plane which ends in a threaded pipe with a “great diameter” which will allow for as much “sludge” as possible to flow so that it is eliminated in the most efficient way. Said sludge is simply the accumulation of the aforementioned floccules.

Even though a great quantity of sludge should not be accumulated in the reactor 4, as it inevitably happens in the decanter 5, it was decided that this “channeller” should be installed to ease the cleaning in the normal maintenance of the device. This channeller ends in a threaded pipe to which a lock valve is attached and which allows evacuation when required.

Last, a threaded pipe is also placed at a third of the total height of the tank of the reactor with a lock valve which will allow the reactor 4 to be emptied at the time of its maintenance to make this process a simpler one.

The decanter in FIGS. 5, 6a, 12 and 13 shows this unit that receives the liquid treated by the electrocoagulation process, which is carried out inside the aforementioned reactor 4.

The liquid is received with thousands of electrically charged particles, floccules, which, in time, bind together and increase their mass until they settle due to their own weight in a still environment, and this process happens in this tank.

One main feature of this unit is that, in this preferred embodiment, it is manufactured with fiberglass reinforced plastic material and it is composed of three components, which, once molded, they are bind together with resin. They become one mono-space container inside of which the liquid flows naturally without the need for mechanical pumps, and finally exits due to supernatant through the upper part (funnel).

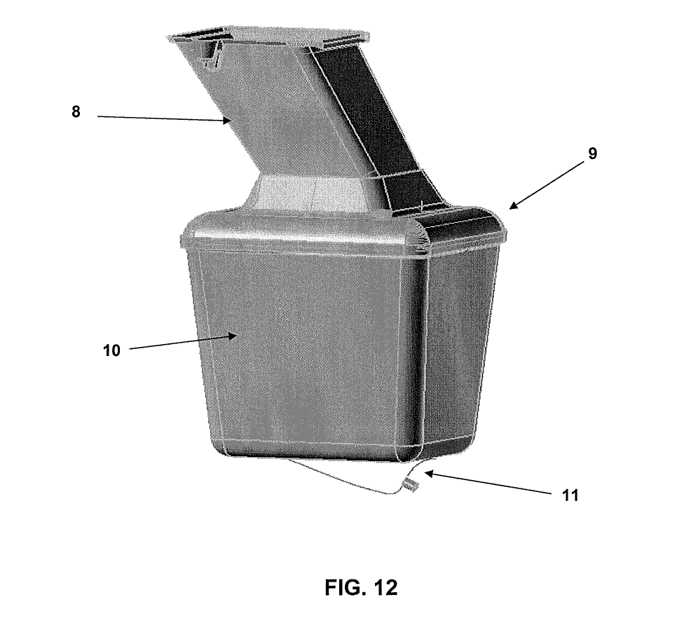

The three components 8, 9 and 10 which make up said mono-space 5 are shown in FIG. 12.

The lower component 10 has in its lower section a channeller 11, similar to the inclined plane mentioned in the reactor 4, to help the sludge flow and, thus, allowing an easy cleaning of the unit. This makes the operation of maintenance possible at a low cost and in a very simple way.

This unit rests over a metal structure or structural base 7b which is shown in FIG. 5.

In addition to this, the upper component is tilted and contains therein several sheets separated from each other, thus allowing the water to flow through them. These tilted sheets, referred to as lamellas, speed up the settlement process which is the aim of this unit. The amount of these sheets may vary according to the type of effluent to be treated.

It should be noted that such lamellas will also be cleaned periodically. For this, the lamellas will be removed from the unit through its upper part, and, once clean, they will be placed back to continue in process. The special configuration of the mono-space unit is in line with the cleaning and maintenance tasks mentioned previously.

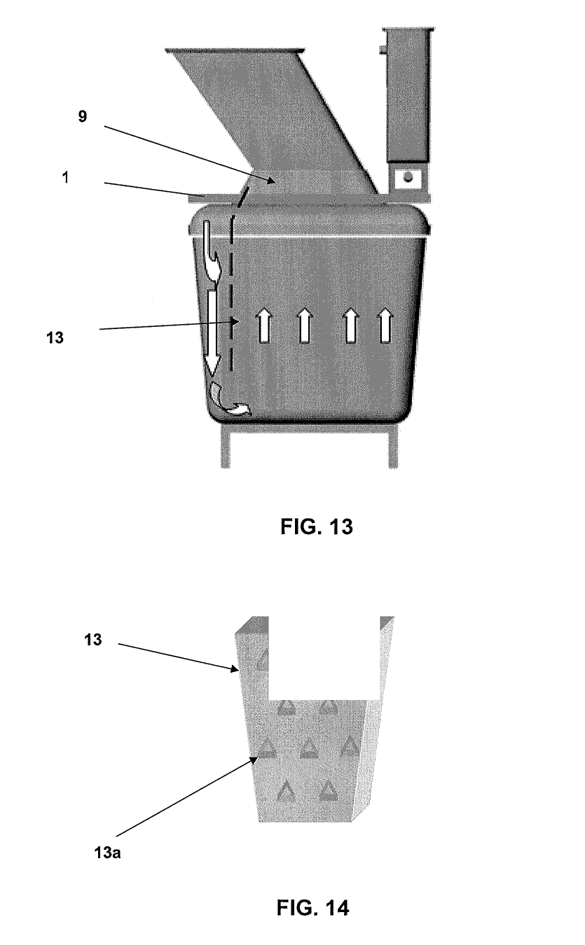

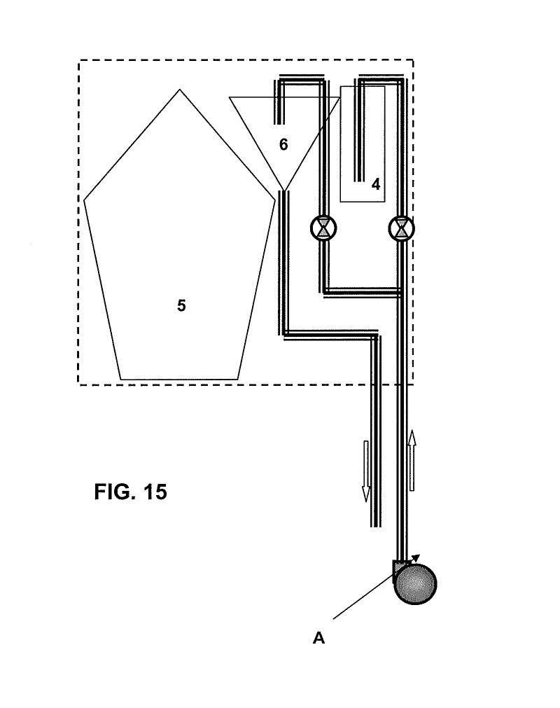

When working, the liquid enters the decanter 5 (FIG. 13), through an opening (passing threaded pipe) 12, on the inside of this nipple a plastic pipe is threaded which ends in an elbow at 90 degrees, thus, it changes the direction of the liquid that entered and sends it frontally against a fiberglass reinforced plastic plate 13, which is firmly attached to the intermediate component 9 described before.

This plate 13 works as a “separator” between the “entrance” area and the primary settlement area. The liquid is forced to flow through the lower part as shown by the arrows in FIG. 13. This type of circulation of the liquid will cause an important “residence time” based on the volume of liquid that enters the reactor 4. The ratio of volume between this unit and the decanter 5 is ten times greater, which allows for a settlement of floccules highly efficient.

This internal plate 13 has, as shown in FIG. 13, several diamond-tip shapes 13a which violently reduce the speed of the liquid by permanently dividing its flow to avoid the agitation of the liquid which entered before and is in the process of increasing its mass, flocculating and, then, settling.

Now, since the liquid continues to enter by its own weight, this unit is filled up through “communicating vessels” and when it enters the upper part 8 of the decanter 5 it runs into the tilted sheets which reduce the kinetic energy of the floccules, and, in turn, favor the “settlement” of these.

At the end of the path, the liquid in its purest state, once again by supernatant, “exits” the system through the “funnel” located in the upper part of the decanter 5.

Regarding the structure of support, it is important to highlight that in this unit there are no screws or bolts which could cause possible losses and/or leaks of the liquid.

To conclude with the structural point of view of this plastic mono-space unit, preferably built in fiberglass reinforced plastic, it should have six “fixings” (three threaded bolts per side) firmly welded to the external part of the intermediate component of this unit 9. An iron squared structure will be mounted on it, shown in FIG. 5 and called “structure of support” 7a. This name was given since said metal structure will “bind” (support) all the tanks of the system described here.

Regarding the decanter tank 5, it will be firmly bolted to the structure of support 7a, and will not be removed during the unit's useful life. However, the reactor 4 and the foam collector 6 will simply rest over the structure 7a; this will make the cleaning of these easier during routine maintenance of the unit. It is important to highlight that the reactor 4 does not rest directly on the structure 7a but on a structure of support 7c, as shown in FIGS. 5, 6b and 10.

The reason for the particular configuration of this unit, its “virtue”, lies in the easiness of its “routine maintenance”. Since the components are plastic and removable, they are extremely easy to clean. Only in rare cases of breakage or malfunction, they can also be easily replaced.

Another aspect of its construction related to the functionality of the maintenance of the system is that it should be taken into account that, after a period of time which could be fixed around every 30 days but that, actually, will depend on the effluents to be treated; the electrodes inside the reactor 4 will need maintenance. This, in the claimed system, can be carried out in a simple way by a person who will lower the tank or reactor 4 down to ground level since its lower part rests on the structure 7c (FIG. 6b). Once on ground level, this person will be able to remove the electrodes and examine them visually, clean them, or change them for a new set of electrodes. In this preferred way, the set of electrodes weights no more than 15 kg, and based on the way they are placed, previously described (as shown in FIGS. 2 and 3), a person alone can do this without needing to make extra effort or use machines such as winches, cranes or riggings.

The electrical cabinet, where the electric and electronic controllers of the system are, will also be mounted on the structure of support 7a.

Also, the interconnection pipes, through which the entering liquid and the liquid heading to the foam collector flow, are firmly fixed to the structure of support 7a together with their corresponding flow adjustment valves.

The foam collector 6 will be preferably built in fiberglass reinforced plastic, with an inclined plane 6a in its lower part (FIG. 11) which favors the circulation of the foam, similar to the sludge channeller described before.

This component 6, as mentioned before, simply rests over the support structure 7a with obviously some type of security fixing.

Attached to this collector 6, there is a sprinkler pipe (FIG. 1) with holes inside of which the untreated liquid flows. When the liquid falls into said tank, it blends and makes the foam that due to supernatant “fell” into this collector 6 dissolve. This liquid, together with the dissolved foam, flows back through an interconnection hose into the cistern tank, as shown in FIG. 1.

It should be pointed out that the liquid which flows back into the cistern tank “A” is the same liquid which flowed out of it, and which now has a minimum of solid floccules inside the “foam”. What is to be pointed out is that these solid substances are non-polluting and may settle in this cistern. But at the same time the floccules are mixed up with the liquid which will flow back into the reactor 4 to be processed.

It is hereby stated that what has been described and drawn is only the preferred way of carrying out this invention and that any other way of carrying out this system will be considered included within the scope of the claims described below.

1. A comprehensive compact unit for the treatment of effluents and/or sewage comprising a reactor in which impurities are decomposed turning into foam and heavy sludge, said reactor makes its clotted effluent into a decanter and makes its foam flow into a foam collector, being said decanter placed adjacent to such foam collector and being able to unload its foam into said collector, being the whole process done by the natural fall of the fluid without auxiliary recirculation devices.

2. The comprehensive compact unit for the treatment of effluents and/or sewage according to claim 1, wherein said reactor comprises a hollow body the upper part of which resembles a funnel with an inclined wall and a lower discharge hole; a foam discharge tray as a connection to the foam collector; a lower base with an inclined plane to which a discharge pipe is connected; and a hole for the inlet of the liquid to be treated; the hollow body of the reactor furthermore comprising multiple electrodes.

3. The comprehensive compact unit for the treatment of effluents and/or sewage according to claim 2, wherein these multiple electrodes are separated by insulating bodies and connected to an electric power source.

4. The comprehensive compact unit for the treatment of effluents and/or sewage according to claim 3, wherein said electrodes are plates with at least two holes, being separators placed between those electrodes, and being said electrodes and separators joined together by cylindrical guide axes.

5. The comprehensive compact unit for the treatment of effluents and/or sewage according to claim 2, wherein, before the inlet of the liquid into the reactor, a number of “cascaded” electrodes are placed comprising successive trays containing the duly electrically connected electrodes, whereby said liquid flows from one tray to the other, by free fall, until it enters the reactor.

6. The comprehensive compact unit for the treatment of effluents and/or sewage according to claim 1, wherein the decanter comprises a hollow body inside of which there is a separating plate close to the fluid inlet pipe to said decanter, comprising a first body and a second oblique body, and the base of said decanter being formed by an inclined plane and a discharge pipe.

7. The comprehensive compact unit for the treatment of effluents and/or sewage according to claim 1, wherein the foam collector comprises a hollow body on top of which an upper sprinkler body is placed.

8. The comprehensive compact unit for the treatment of effluents and/or sewage according to claim 1, wherein said reactor, decanter, and foam collector are placed on a support structure, said reactor resting on a lower structure and the decanter resting on a lower support structure.

9. A system used by the unit of claim 1, comprising a cistern tank inside of which there is a submersible pump connected to the reactor and to the foam collector through valves; said reactor discharging the clotted effluents into the decanter and the foam into the foam collector, wherein the decanter discharges its foam into said foam collector.
